(19) United States
(12) Patent Application Publication
(10) Pub. No.: US 2009/0017430 A1
(43) Pub. Date: Jan. 15, 2009

(54) Virtual surgical training tool

(75) Inventors: Holger Muller-Daniels, Gettorf (DE); Stephen F. Hansen, Ridgewood, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Stryker Trauma GmbH, Schonkirchen (DE)

(21) Appl. No.: 12/152,658

(22) Filed: May 15, 2008

Related U.S. Application Data
(60) Provisional application No. 60/930,417, filed on May 15, 2007.

(51) Int. Cl. G09B 23/28

(52) U.S. Cl. 434/262

(57) ABSTRACT

Techniques for providing a virtual operating space for performing a virtual surgical procedure. The technique includes generating a three-dimensional view of a virtual operating space comprising one or more virtual objects capable of being manipulated by a user for performing one or more operating steps in a virtual surgical procedure on one or more virtual patients. The technique also includes manipulating the one or more virtual objects in the virtual operating space to perform all or part of a virtual surgical procedure. The technique further includes generating a virtual radiographic image of one or more portions of the virtual patient at least following the performance of one or more steps of the virtual surgical procedure to provide visual feedback to the user regarding the performance of the one or more steps in the virtual surgical procedure.

### CROSS-REFERENCE TO RELATED APPLICATION

This application claims the benefit of the filing date of U.S. Provisional Patent Application No. 60/930,417 filed May 15, 2007, the disclosure of which is hereby incorporated herein by reference.

### FIELD OF THE INVENTION

This application relates to techniques for generating a virtual operating space for performing a virtual surgical procedure, and particularly to a virtual surgical training tool configured to provide such techniques.

### BACKGROUND OF THE INVENTION

Various training and educational techniques are available to help prepare doctors or other health care professionals for actual surgical procedures. For example, a doctor may view a video showing an actual surgical procedure and/or read instructional manuals regarding such procedures. In another technique, the doctor may perform a simulated surgical procedure using real instruments on a physical model of a human body part. Improvements in training techniques for performing surgical procedures, however, are desired.

### SUMMARY OF THE INVENTION

In one aspect of the present application, disclosed is a method, apparatus or computer readable medium configured to provide a virtual operating space for performing a virtual surgical procedure. The computer implemented method includes generating a three-dimensional view of a virtual operating space comprising one or more virtual objects capable of being manipulated by a user for performing one or more operating steps in a virtual surgical procedure on one or more virtual patients. The method further includes manipulating the one or more virtual objects in the virtual operating space to perform all or part of a virtual surgical procedure. The method further includes generating a virtual radiographic image of one or more portions of the virtual patient at least following the performance of one or more steps of the virtual surgical procedure to provide visual feedback to the user regarding the performance of the one or more steps in the virtual surgical procedure.

In another aspect an apparatus for providing a virtual operating space for performing a virtual surgical procedure, is disclosed. The apparatus includes a processor, and a storage device storing instructions that are executed by the processor. The instructions when executed generate a three-dimensional view of a virtual operating space comprising one or more virtual objects capable of being manipulated by a user for performing one or more operating steps in a virtual surgical procedure on one or more virtual patients. The instructions also manipulate the one or more virtual objects in the virtual operating space to perform all or part of a virtual surgical procedure. Additionally, the instructions generates a virtual radiographic image of one or more portions of the virtual patient at least following the performance of one or more steps of the virtual surgical procedure to provide visual feedback to the user regarding the performance of the one or more steps in the virtual surgical procedure.

In another aspect a method of providing a virtual operating space for performing a virtual surgical procedure is disclosed. The method includes generating a three-dimensional view of a virtual operating space of virtual objects comprising a virtual patient, at least one virtual bone forming a part of the virtual patient, at least one virtual implant and at least one virtual tool for implanting the implant in the bone. The method also includes manipulating the one or more virtual objects in the virtual operating space to perform all or part of the virtual orthopedic surgical procedure. Additionally, the method includes generating a virtual radiographic image of one or more portions of the virtual patient at least following the performance of one or more steps of the virtual surgical procedure to provide visual feedback to the user regarding the performance of the one or more steps in the virtual surgical procedure.

In yet another aspect an apparatus for providing a virtual operating space for performing a virtual surgical procedure is disclosed. The apparatus includes a means for generating a three-dimensional view of a virtual operating space comprising one or more virtual objects capable of being manipulated by a user for performing one or more operating steps in a virtual surgical procedure on one or more virtual patients. The apparatus also includes a means for manipulating the one or more virtual objects in the virtual operating space to perform all or part of a virtual surgical procedure. Additionally, the apparatus included a means for generating a virtual radiographic image of one or more portions of the virtual patient at least following the performance of one or more steps of the virtual surgical procedure to provide visual feedback to the user regarding the performance of the one or more steps in the virtual surgical procedure.

### BRIEF DESCRIPTION OF THE DRAWINGS

FIG. 1 is a block diagram of a virtual surgical procedure training tool in accordance with an embodiment of the present application.

FIG. 2 is a flow diagram of the operation of the virtual surgical procedure training tool of FIG. 1 in accordance with an embodiment of the present application.

FIGS. 3-14 show screen shots of the operation of the virtual surgical procedure training tool of FIGS. 1 and 2 in accordance with an embodiment of the present application.

Like reference numerals indicate like elements.

### DETAILED DESCRIPTION

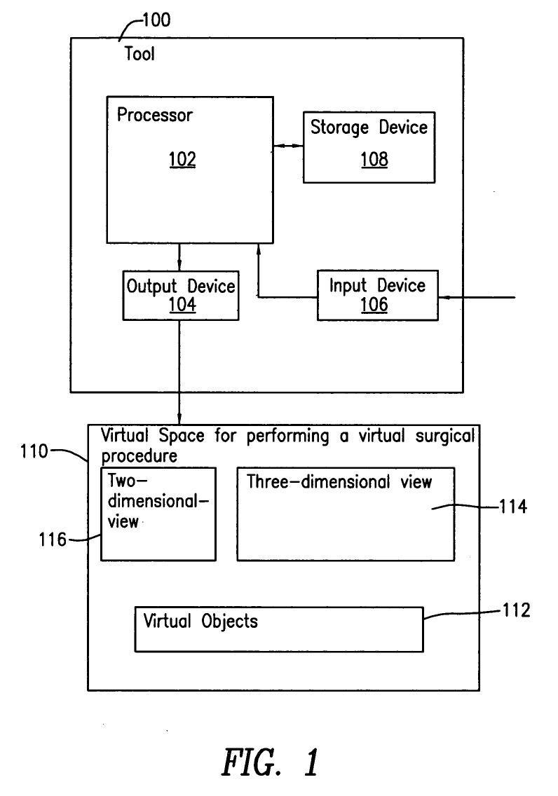

FIG. 1 shows a block diagram of a virtual surgical procedure training tool 100 to allow a user to perform a virtual surgical procedure in accordance with an embodiment of the present application. The virtual surgical procedure training tool (hereinafter, tool) 100 comprises a processor 102 connected to an output device 104, input device 106, and a storage device 108. The processor 102 executes one or more programs for implementing the techniques of the tool 100 of the present application. The output device 104 provides a user with feedback regarding the operation of the tool. The input device 106 receives commands and/or data for controlling the operation of the tool. The storage device 108 stores programs comprising processor executable instructions and data required for the execution of the programs.

As explained below in detail, the tool 100 is configured to provide a virtual operating space 110 comprising a three-dimensional view 114 of the virtual operating space for performing a virtual surgical procedure on a virtual patient, a two-dimensional view 116 of a portion of the virtual operating space, and virtual objects 112 capable of being manipulated for performing the virtual surgical procedure on the virtual patient. The virtual operating space may be defined as a computer-generated three-dimensional environment that simulates a three-dimensional reality. The three-dimensional view 114 may include virtual objects necessary for performing a virtual surgical procedure. For example, the three-dimensional view 114 may comprise a virtual operating room including virtual objects such as a patient undergoing the procedure and virtual medical devices such as a virtual imaging device including an X-ray machine configured with a C-arm or other objects based on the requirements of the surgical procedure. The two-dimensional view 116 includes a virtual radiographic image of portions of the patient following the performance of a step in the virtual surgical procedure. For example, the radiographic image may be a simulated x-ray of a portion of the patient such as the surgical area (e.g., the torso area) of the patient undergoing the procedure or other areas. The virtual objects 112 may include medical objects necessary to perform the surgical procedure such as prosthetic implants, cutting devices for making canals in bones for insertion of such implants or other devices.

The tool 100 will be described in the context of a virtual orthopedic surgical procedure involving fixing a femur bone fracture of a virtual patient which includes implanting an implant into a canal of the femur bone. However, it will be appreciated that the techniques of the present application may be equally applicable to other orthopedic surgical procedures such as the repair of the tibia as well as other non-orthopedic surgical procedures such as vascular surgical procedures. In addition, the tool generates virtual radiographic images but it will be appreciated that the tool can be configured to provide other medical imaging techniques such as magnetic resonance imaging (MRI), fluoroscopic images, nuclear medicine images from gamma cameras, tomographic techniques such as computed tomography (CAT or CT), ultrasonic images or other medical imaging techniques, diagnostic or non-diagnostic techniques well known in the art. The techniques of the present application, such as generating the virtual operating space, can be implemented using well known techniques including virtual reality modeling and languages. The virtual objects can be generated using well known three-dimensional modeling techniques. For example, polygonal modeling techniques can be used to model real objects for use in surgery, such as an implant, into virtual objects for use in the virtual surgery.

The processor 102 can be implemented using any mechanism capable of executing a set of instructions for implementing a virtual operating space for performing a virtual surgical procedure. The processor can be implanted using hardware, software or a combination thereof. For example, the processor 102 can be a client computer which is connected to a server computer over a network such as the Internet. The client computer can be a personal computer (PC) and the program and data for implementing the techniques of the present application can be downloaded from the server computer for execution on the client computer. In another embodiment, the PC can be configured to operate in a stand-alone manner without a network connection. In other embodiments, the processor can be implemented as, without limitation, handheld devices such as a personal data assistant (PDA), a desktop computer, laptop or notebook, portable computer, tablet computer, wearable computer or a combination thereof.

The output device 104 can be any mechanism for providing feedback to a user of the tool. The output device can include a device for providing audio output signals and a device for providing visual output signals regarding the operation of the tool. For example, in a PC embodiment, the output device for providing visual output can include a computer display and a video card that processes and renders the virtual operating space from the processor to the computer display. Also, in a PC embodiment, the output device for providing audio output can include a speaker. In addition, haptic techniques can be employed including providing the user with interfaces via the sense of touch by applying forces, vibrations and/or motions to the user.

The input device 106 can be any mechanism for receiving commands for controlling the operation of the tool. For example, in a PC embodiment, a keyboard in combination with a mouse can be used to input commands into the tool which can be interpreted by the processor according to predefined functions. In other embodiments, the input device can be part of the output device. For example, the input device can be a touch screen as part of computer display. The input device can be interconnected to the tool using any connection mechanism capable of exchanging data between the tool and the input device. For example, the connection mechanism can include, but is not limited to, wireless, IR, mechanical or other mechanism. The input device can be located in the same room as the tool or remote to the tool such as in another room or other geographic location such as a different country than that of the tool.

The storage device 104 can be any mechanism for storing and retrieving programs comprising processor executable instructions and data for the operation of the programs. For example, the storage device can comprise one or more memory devices such as solid state device known as random access memory (RAM) or other forms of fast but temporary storage. The storage device also can comprise mass storage such as optical discs, forms of magnetic storage such as hard disks, and other types of storage which are slower than RAM, but of a more permanent nature. The storage device can be a combination of the above storage techniques and can be located in one location or distributed over one or more remote locations. The storage device can be configured to store and retrieve data in the form of a database or other configuration well known in the art.

In a preferred embodiment, the techniques of the present application can be implemented as software stored on storage medium such as a compact disk (CD), hard disk, removable disk or other means of storing computer executable instructions. The software includes computer executable instructions for performing the steps of the techniques of the present application. The software can be configured to operate on a single computer, distributed computer configuration, a network of computers located remotely or locally or any other computer configuration well known in the art.

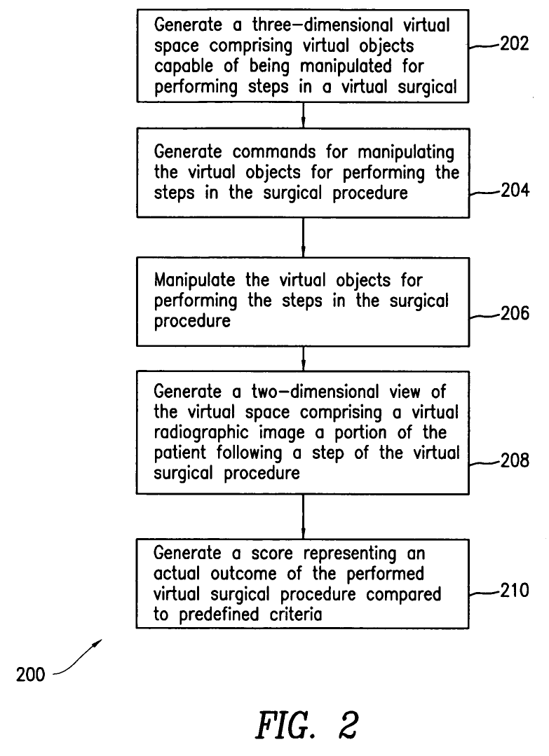

FIG. 2 is a flow diagram 200 of the operation of the tool 100 of FIG. 1 in accordance with an embodiment of the present application. As explained above, the training tool 100 will be described in the context of a virtual orthopedic surgical procedure involving fixing a femur bone fracture of a virtual patient which includes implanting an implant into a canal of the femur bone. For ease of description, only a portion of the process for performing a virtual surgical procedure is provided below. In any event, it will be appreciated that the steps in the process described below can be executed in a different order while still being within the scope of the present application.

In step 202, the tool 100 generates a three-dimensional virtual operating space comprising virtual objects capable of being manipulated for performing steps in a virtual surgical procedure. For example, in one embodiment, the virtual operating space can comprise a virtual operating room space and a virtual object selection space. The operating room space is a three-dimensional view representing an actual operating room for performing a virtual orthopedic surgical procedure on the patient. The operating room space can include virtual objects which may be found in an actual operating room as part of surgical procedure. For example, the virtual operating space may include a virtual object representing a patient who is to undergo a surgical procedure, a table for supporting the patient and a radiographic imaging device for generating radiographic images of the patient during the surgical procedure. The virtual object selection space is a three-dimensional view of various virtual objects for selection by the user for use during the surgery. The virtual objects represent objects which are used in an actual surgical procedure. For example, the virtual objects can include implants for implantation into a bone of the patient.

In step 204, the tool generates commands for manipulating the virtual objects for performing the steps in the surgical procedure. The commands can be received from a user via an input device such as a keyboard in combination with a mouse, as described above. The commands can comprise commands to manipulate the virtual objects in the virtual operating space in accordance with one or more steps in the virtual surgical procedure. Manipulation of the virtual objects may be defined as operations that can be performed on the objects in the virtual operating space such as rotation of the objects about an axis, movement of the objects between two points in the virtual operating space, modification of characteristics of the objects such as shape or other operations that can be performed on the objects. For example, in an orthopedic surgical procedure, the user can enter commands to select an implant from the virtual object selection space and advance the implant towards the bone of the patient in the virtual operating room space.

In another embodiment, the tool can automatically generate commands in a sequential manner for performing one or more or all of the steps in the virtual surgical procedure. This feature allows the user to view the proper manner of performing one or more steps of surgical procedure. For example, in an orthopedic virtual surgical procedure, the tool could be selected to automatically perform the implantation process by selecting the proper implant and implanting into the bone of the patient.

In another embodiment, the tool provides for commands to selectively adjust a visibility characteristic of objects in the virtual operating space. For example, the virtual operating space may include an object representing a patient and the user may be able to selectively make the patient transparent to allow the user to view through patient for a particular purpose and then the user can make the patient opaque when complete or for another purpose.

In step 206, the tool manipulates the virtual objects for performing the steps in the virtual surgical procedure. The virtual objects are manipulated based on the commands received during step 204. As explained above, the user can selectively manipulate the objects during each step of the procedure. The commands generated by the user can be stored for later retrieval to provide a history of the virtual surgical procedure. Alternatively, the user can have the tool automatically generate the commands so as to automatically perform the virtual surgical procedure according to a predefined template without requiring user input. In one embodiment, the tool has the capability to assist the user in manipulating an object during a step in the procedure. For example, the user can initially select an object, such as an implant, and then begin advancing it towards a destination such as the canal of a bone. As the implant is being advanced toward the canal, the tool can assist the user by automatically guiding or inserting the implant when the implant is a predefined position relative to the canal of the bone. This feature may help the user gain confidence in performing an actual surgical procedure. The commands generated by the user can be stored for later retrieval to provide a history of the virtual surgical procedure.

Once the virtual objects have been manipulated, the tool, in step 208, generates a two-dimensional view of the virtual operating space comprising a virtual radiographic image of a portion of the patient following a step of the virtual surgical procedure. The user can generate commands to selectively generate the two-dimensional view of the portion of the virtual operating space before, after, as well as during performance of a step in the virtual surgical procedure. This provides the user with the capability to view virtual radiographic images and gain experience reading the images without having to be exposed to radiation from real radiographic images. In addition, generating virtual radiographic images is less costly and safer than generating real radiographic images. The radiographic images can be stored for later retrieval to provide a history of the virtual surgical procedure.

In step 210, the tool generates a score representing an actual outcome of the performed virtual surgical procedure compared to predefined criteria. The score can provide a measurement of the performance of each step as well as the complete surgical procedure. The score can be assigned to one or more aspects of a step of the surgical procedure. For example, a score can provide a measure indicating whether the correct surgical tool was selected for the procedure, measure of the length of time a step took to complete, measure of whether the use of the tool was proper or measures of other aspects of the procedure. The score can be presented in any manner such as graphical including a pie chart or table, audio including spoken words or any other well known manner.

In one embodiment, the score can be a number in a predefined range of numbers. For example, the range of numbers can be 1 through 16 where the value “1” represents a poor score and the value “16” represents a good score. Aspects of the actual performance of one or more steps of the procedure can be measured and compared to a predefined criteria or template indicating proper performance of the aspect. For example, a step in a procedure may require a particular selection of a tool and a proper use of the tool on the patient. During a step of the surgical procedure, the user may select a tool and use the tool in a particular manner. The tool compares the actual performance of the step to the predefined criteria to generate a score. The score helps provide objective and subjective measurements of the user's performance of the surgical procedure. The score data can be stored in the tool for later retrieval to provide a history of the user's performance.

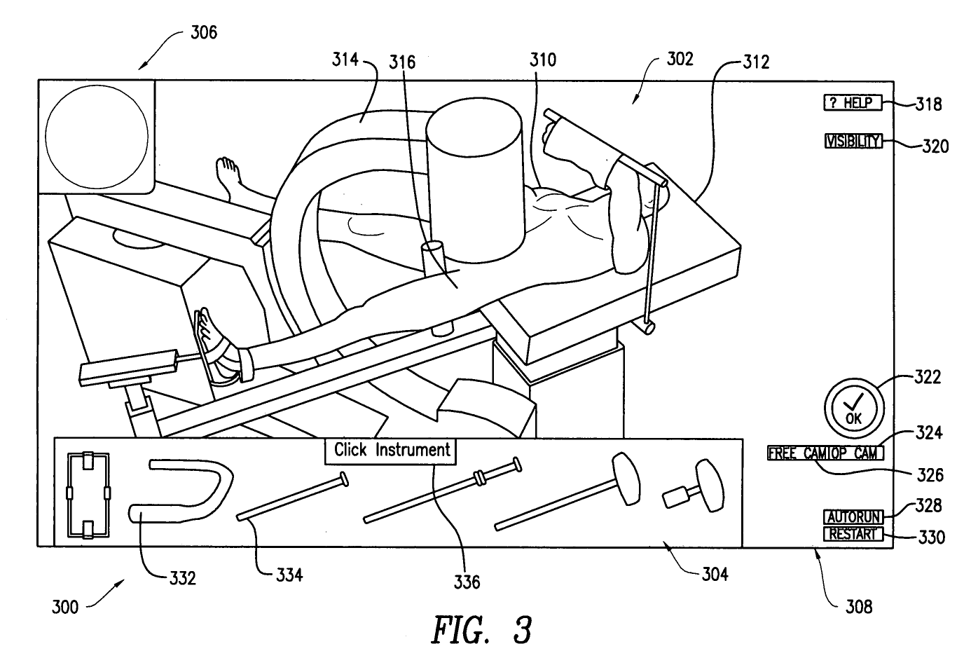

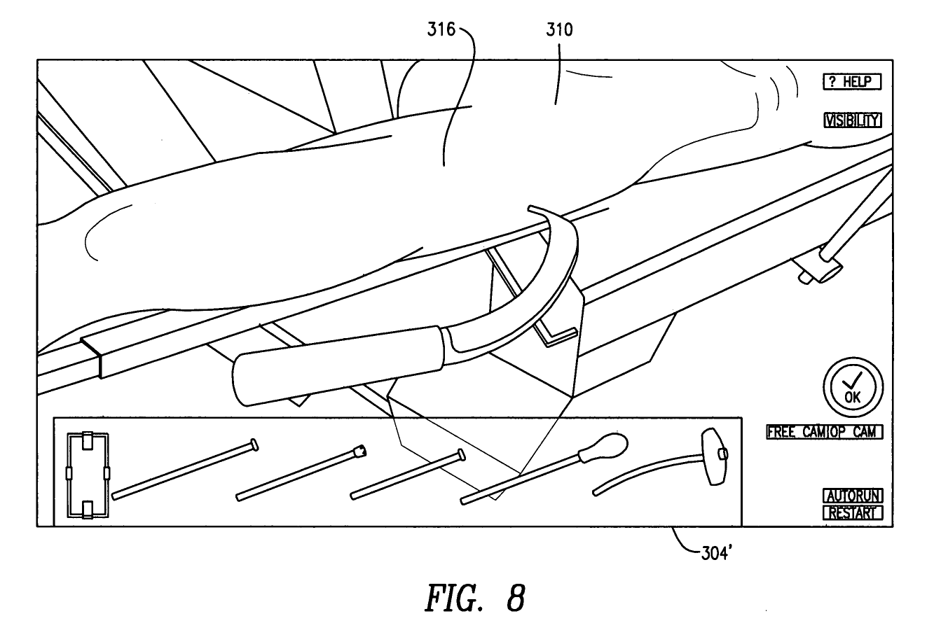

FIGS. 3-14 show screen shots of the operation of the virtual surgical procedure training tool in accordance with an embodiment of the present application. The screen shots represent output graphical images generated by the tool 100 during the performance of the virtual surgical procedure. The screen shots are described in the context of a virtual orthopedic surgical procedure involving fixing a femur bone fracture of a virtual patient which includes implanting an implant into a canal of the femur bone. However, as explained above, it will be appreciated that the techniques of the present application are equally applicable to other orthopedic surgical procedures such as the repair of the tibia as well as other non-orthopedic surgical procedures such as vascular surgical procedures. For ease of explanation, it will be assumed that the tool is implemented on stand-alone PC where the central processing unit (CPU) of the PC is the processor for executing the program for providing a virtual operating space for performing the virtual surgical procedure, a computer display of the PC is the output device for displaying the virtual operating space, a keyboard and mouse of the PC are the input devices for receiving commands for controlling the operation of the tool, and an internal memory of the PC is the storage device for storing the programs and data used in the operation of the program. However, as explained above, it is appreciated that the tool can be implemented using other well known digital or analog processing mechanisms.

Turning to FIG. 3, shown is an initial screen shot illustrating a virtual operating space 300 to allow a user to perform a virtual orthopedic surgical procedure. The virtual operating space 300 comprises a virtual operating room window 302, a virtual object selection window 304, a radiographic image window 306 and a feature selection window 308.

The operating room window 302 is a three-dimensional view of a real operating room for performing the virtual orthopedic surgical procedure on the patient. For example, the window includes virtual objects representing a virtual patient 310 who is to undergo the surgical procedure, a virtual table 312 for supporting the patient and a virtual radiographic imaging device 314 for generating simulated radiographic images of the patient during the surgical procedure. In this example, the virtual patient 310 is shown as a complete human body but it will be appreciated that other embodiments are possible. For example, the tool can show a part of the human body such as the torso, more than one patient, a non-human body such as that of an animal or a combination thereof. The radiographic imaging device 314 is shown as an X-ray imaging machine configured with a C-arm. However, it will be appreciated that other medical imaging devices can be used. For example, a virtual CT imaging device can be used instead of the X-ray machine or in combination therewith.

The virtual object selection window 304 is a three-dimensional view of various virtual objects for selection by the user during the surgical procedure. For example, the virtual objects can include virtual implants, virtual tools or instruments for making canals in a bone of the patient, virtual tools or instruments for implantation of the implants into the bone of the patient and other objects required for performing the surgical procedure. The window 304 provides a prompt 336 instructing the user to select an instrument.

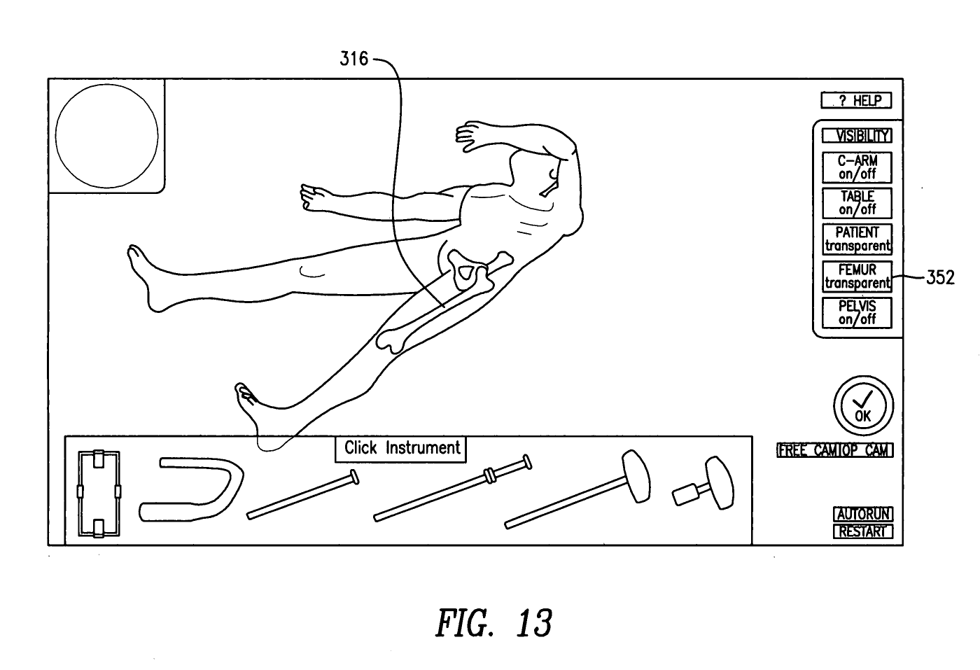

The radiographic image window 306 is a two-dimensional view representing a radiographic image of a portion of the patient taken during some point in the surgical procedure. For illustrative purposes, the image window 306 shows a radiographic image of a portion of a femur 316 (best shown in FIG. 13) of the patient 310 that is undergoing the procedure. As will be explained below, the user can command the tool to generate one or more radiographic images of the patient or a portion of the patient during any step of the procedure.

The feature selection window 308 provides the user with the capability of selecting various features related to the virtual operating space. For example, the window 308 shows a HELP button 318, a VISIBILITY button 320, an OK button 322, an OP CAM button 324, a FREE CAM button 326, an AUTORUN button 328 and a RESTART button 330.

Activation of the HELP button 318 triggers a function of the tool which can provide information related to various aspects of the tool. The information can include information regarding navigating the various screens of the tool. The information can also include assistance with various aspects of the surgical procedure such as proper tool selection, techniques for use of the tool or other information which may be of use in performing the surgical procedure.

Activation of the VISIBILITY button 320 triggers a function of the tool, as described below in further detail, which provides the user with the ability to selectively adjust visibility characteristics of the virtual objects such as making one of the objects transparent.

Activation of the OK button 322 triggers a function of the tool which allows the user to confirm a particular operation such as the selection of an object from the selection window 304.

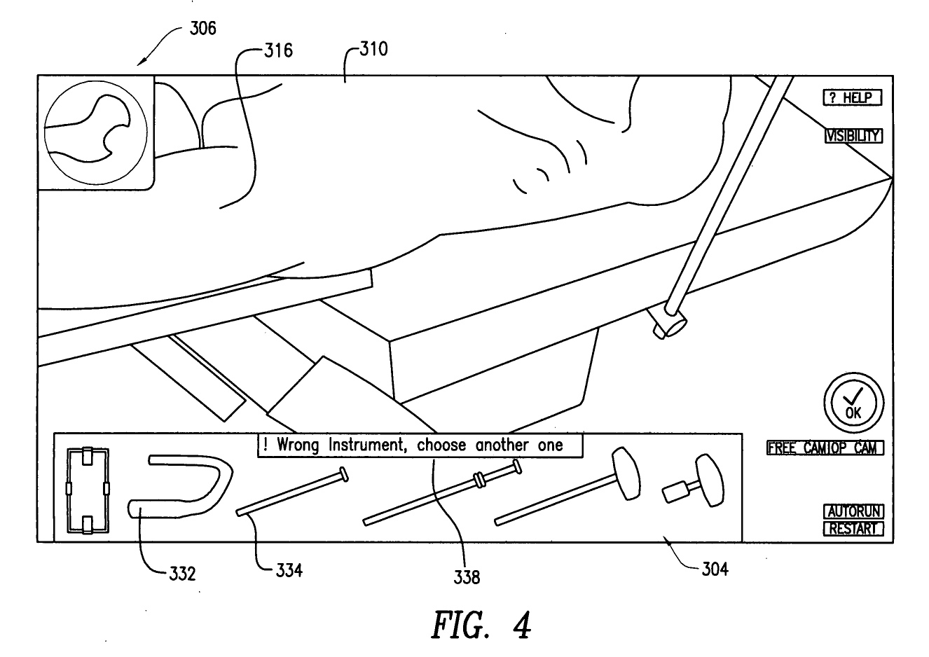

Activation of the OP CAM button 324 triggers a function of the tool which allows the user to select a view of the virtual operating room from the perspective of a surgeon relative to the area of the patient undergoing the surgical procedure (best shown in the screen shot of FIG. 4).

Activation of the FREE CAM button 326 triggers a function of the tool which allows the user to select views of the virtual operating room from different angles by manipulating the position of a virtual camera in the virtual room. The screen shot of FIG. 3 shows a view of the operating room from a top perspective.

Activation of the AUTORUN button 328 triggers a function of the tool which causes the tool to automatically perform one or more steps of the virtual surgical procedure.

Activation of the RESTART button 330 triggers a function of the tool which causes the tool to restart the surgical procedure to allow the user to perform the surgical procedure from the first step or from a previous step based on the configuration of the tool. Several of these features will be explained below in further detail. It will be appreciated that the above is one embodiment and that other functions and configurations are contemplated.

As explained above, the tool can be implemented using a PC. As such, the input device can be a keyboard in combination with a mouse and be configured to perform various functions related to the operation of the tool. For example, the arrow keys of the keyboard can be assigned to perform functions related to the FREE CAM button 326 to control the virtual camera such as rotating the camera in a particular direction or angle. Other keys can be assigned to perform Zoom functions such as providing the user with a close up view of a particular aspect of the virtual operating space. Another key can be assigned to trigger a radiographic image function to generate radiographic images. With respect to the mouse device, the left button of the mouse device can be assigned as the selection button and used to select, drag and drop a virtual object such an implant in the virtual operating space. It will be appreciated that the above is one embodiment and that other functions and configurations are contemplated.

FIG. 4 shows a screen shot illustrating a view of the area of the patient undergoing the surgical procedure. The user activates the OP CAM button 324 which causes the tool to provide a view of the surgical area of the patient undergoing the surgical procedure compared to the operating view shown in FIG. 3. As explained above in the context of FIG. 3, the selection window 304 prompts the user to select an instrument. In a first step of the procedure, the user selects an instrument using the mouse device. The tool compares the selected instrument to the instrument indicated in a predefined template for the procedure. In the event the user makes an improper selection, the tool alerts the user to this situation in the form of a prompt 338, as shown in the screen shot of FIG. 4. Thus, the tool helps train the user in performing the surgical procedure by providing feedback.

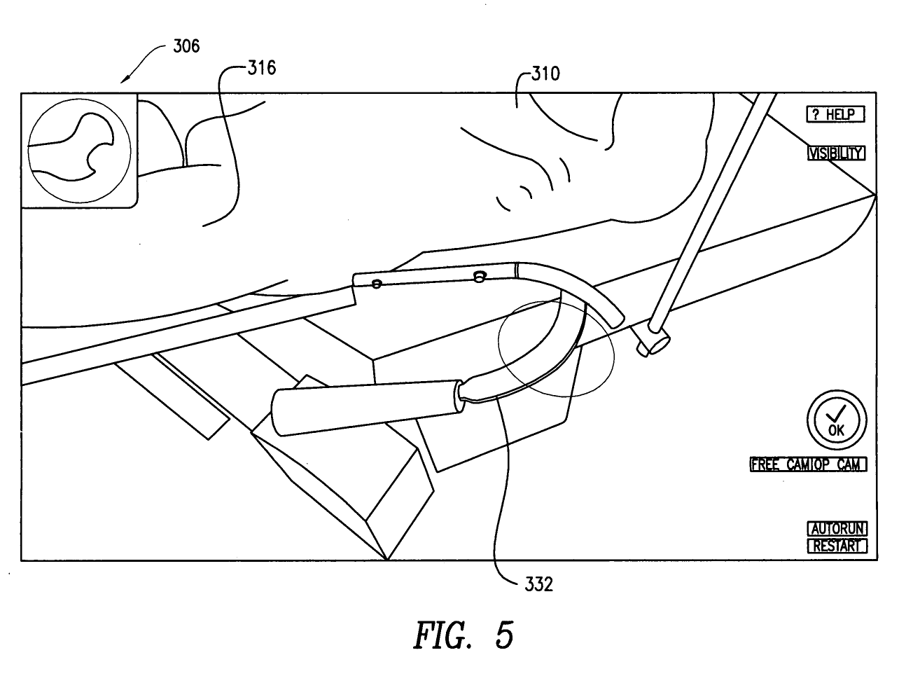

FIG. 5 shows a screen shot illustrating the proper selection of an instrument for the performance of a step of the surgical procedure. Once the proper instrument or virtual object has been selected, the user can manipulate the instrument in accordance with the requirements of the step in the procedure. In this case, the user selects instrument 332 and advances the instrument toward the femur bone 316 of the patient 310. Although not shown, the tool can provide feedback information to the user as the user advances the instrument towards the patient. For example, the tool can generate an audio signal, a visual signal or a combination thereof if the user is not using the instrument properly. In this manner, the tool can provide assistance to the user during the procedure and help improve the user's surgical skills. Alternatively, the user can activate the AUTORUN button which will cause the tool to automatically manipulate the instrument to perform the step of the procedure. The user also can activate the RESTART button to cause the tool to restart the step of the procedure. These features help improve the surgical skills of the user by allowing the user to repeat particular steps in which the user may require additional training.

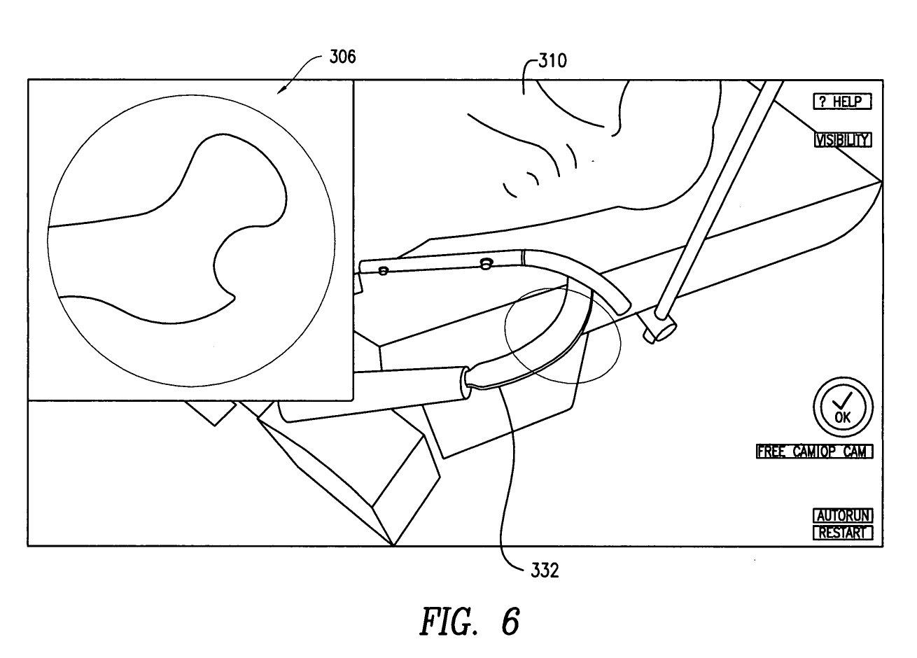

FIG. 6 shows a screen shot illustrating a radiographic image of a surgical area of the patient undergoing a step in the surgical procedure. The screen shot shows an enlarged radiographic image 306 of the femur bone of the patient 310. The user can depress a predefined key of the keyboard to activate the radiographic image generation function of the tool which causes the tool to generate a radiographic image. This feature provides the user with the capability of generating virtual radiographic images of a portion of the virtual patient during the virtual surgery, essentially in real-time. Such techniques may help improve the user's radiographic image reading skills without having the user exposed to real radiographic images. Once the user is satisfied with the radiographic image, the radiographic view 306 can be minimized to allow the user to more clearly view the surgical area of the patient undergoing the procedure and proceed to the next step of the procedure.

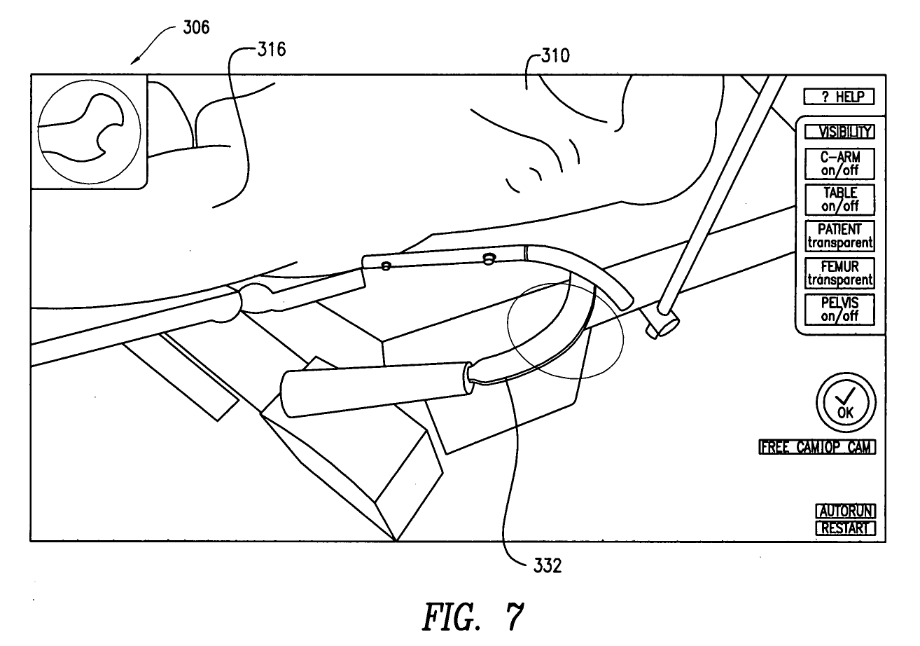

FIG. 7 shows a further screen shot of a step of the surgical procedure. The instrument is shown properly attached to femur bone 316 of the patient. The tool detects this situation and updates the selection window 304′ with additional instruments or tools for the next step in the surgical procedure. Thus the user is provided with an interactive training tool which allows the user to manipulate virtual objects for performing a virtual procedure and receive feedback from the tool as the virtual objects are being manipulated.

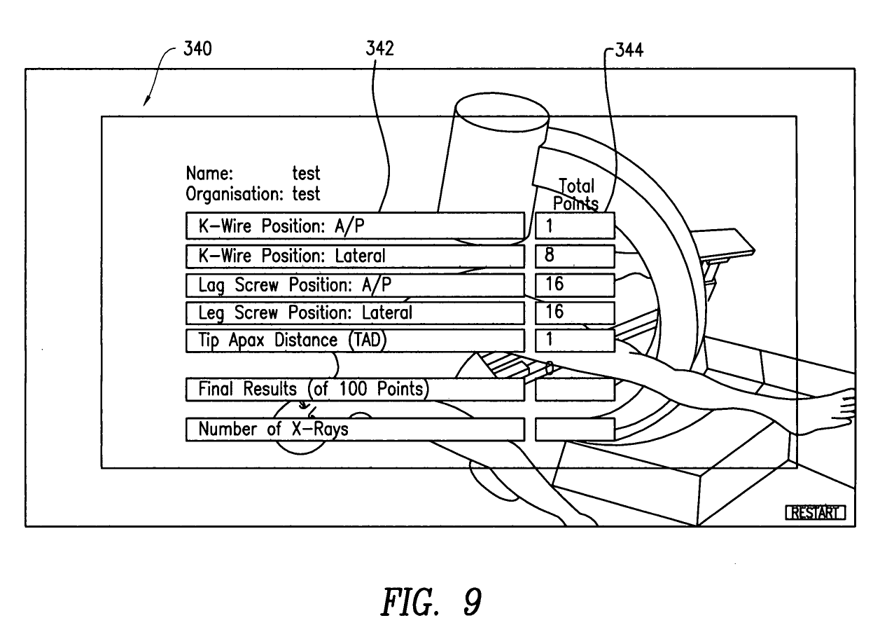

FIG. 9 shows a screen shot showing a score provided at the completion of the surgical procedure. For illustrative purposes, it will be assumed that all of the steps of the surgical procedure have been performed. As such, the tool detects the completion of the procedure and generates a score 340. The score 340 is in the form of a table comprising rows having descriptions of a step 342 and a corresponding score 344. As explained above, the score provides the user with feedback regarding the performance of the procedure according to predefined criteria. However, it will be appreciated that other representations of the score as well as other measurements are contemplated such as animated representations including audio and video output.

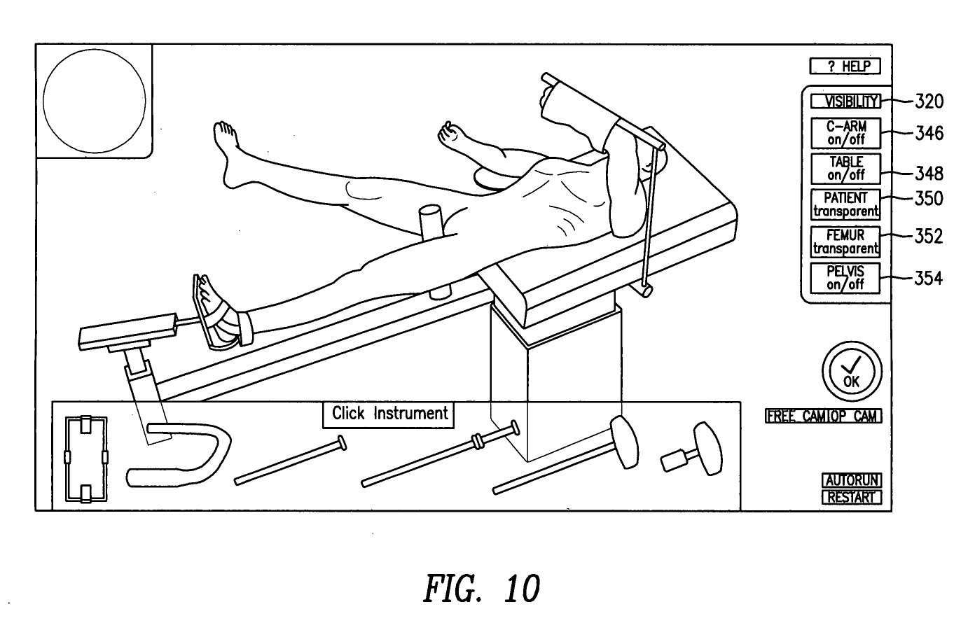

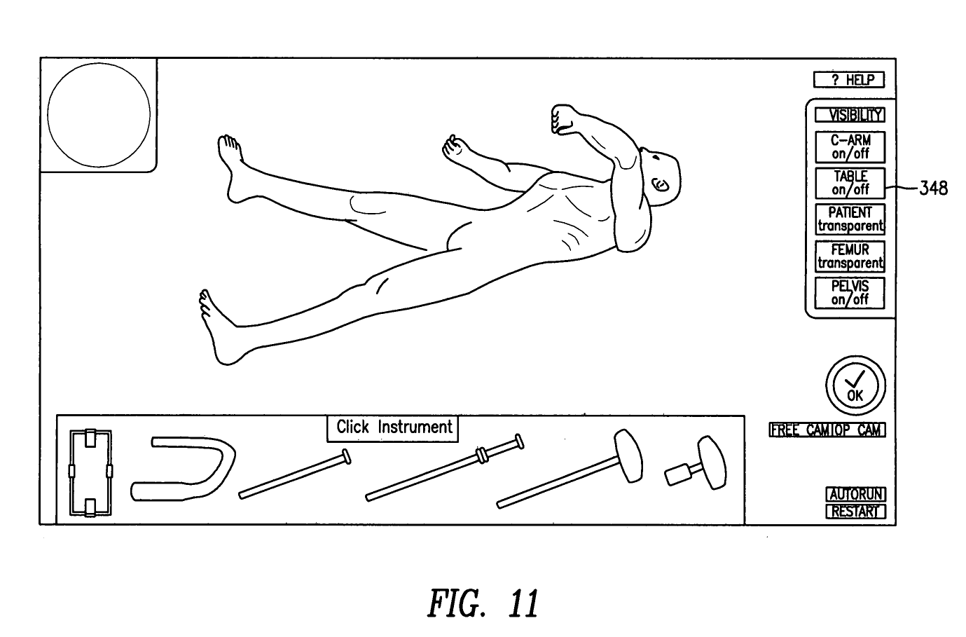

FIGS. 10-14 show screen shots illustrating user selectable features for adjustment of transparency characteristics of various virtual objects of the virtual operating space. FIG. 10 shows a screen shot with VISIBILITY options 320 including a C-ARM button 346, a TABLE button 348, a PATIENT button 350, a FEMUR button 352 and a PELVIS button 354. The C-ARM button 346 allows the user to activate a function of the tool to cause the virtual radiographic imaging device 314 shown in FIG. 3 to disappear as shown in FIG. 10. This reduces the number of objects in the virtual operating space thereby reducing obstructions in the virtual operating room and helping the user focus on the surgical procedure. The user can reactivate the C-ARM button 346 to cause the virtual radiographic imaging device to reappear, if necessary. Likewise, the TABLE button 348 can allow the user to activate a function of the tool to make the virtual table 312 of FIG. 3 disappear as shown in FIG. 11. Of course, the user can reactivate the TABLE button 346 to cause the virtual table to reappear.

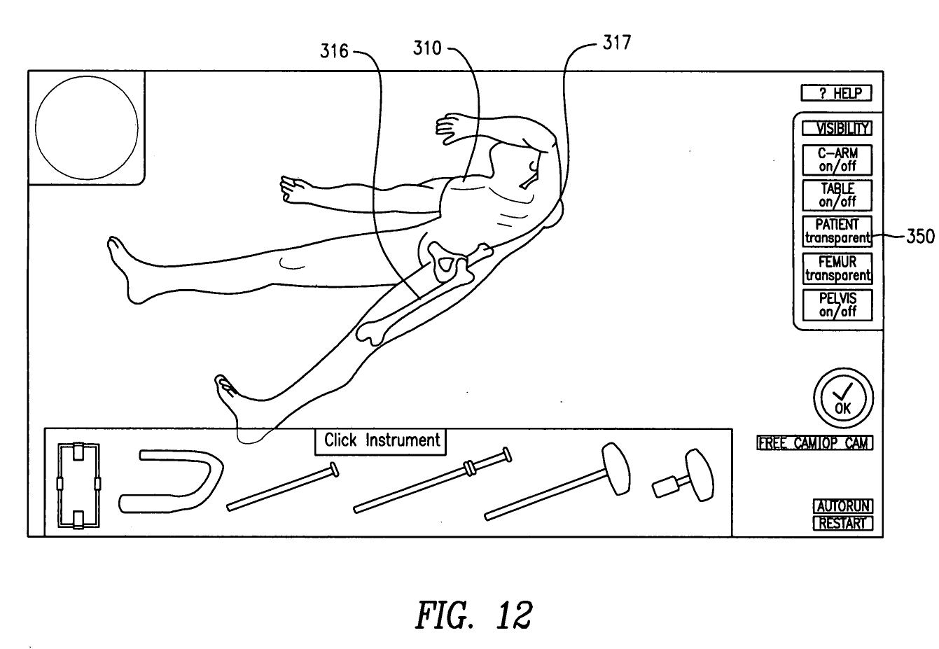

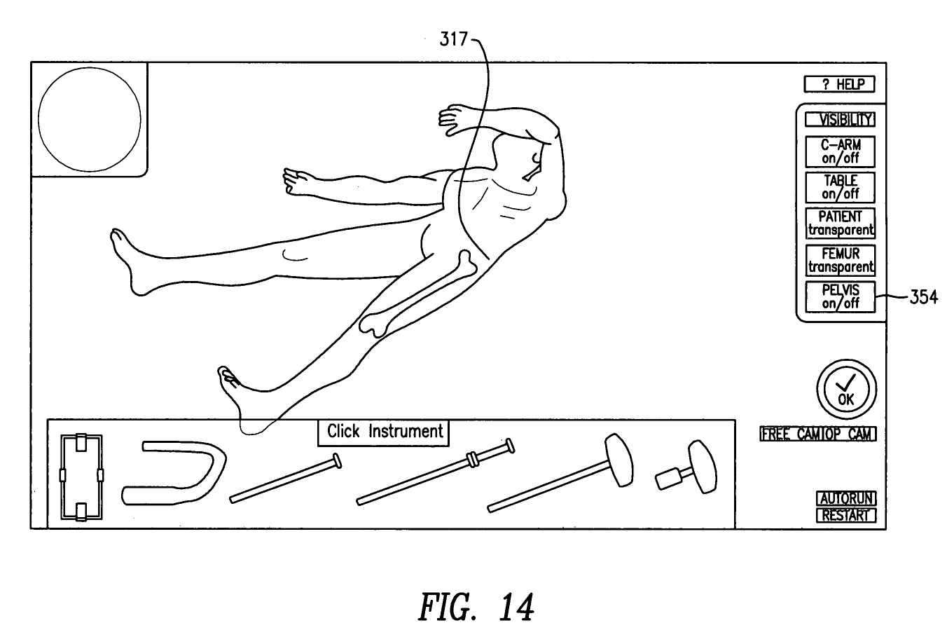

The PATIENT button 350 can allow the user to activate a function of the tool to make the virtual patient 310 transparent as shown in FIG. 12. In a similar manner, the FEMUR button 352 can allow the user to activate a function of the tool to make the femur bone transparent as shown in FIG. 13. Similarly, the PELVIS button 354 can allow the user to activate a function of the tool to make the pelvis bone 317 transparent as shown in FIG. 14. Of course, the user can reactivate any of the above functions to cause the virtual objects to be non-transparent. These features provide the user with additional training experience by providing the user with transparent views of virtual objects which are not possible with real objects.

The techniques of the present application provide one or more of the following advantages. The tool provides a doctor or other healthcare professional with a virtual operating room for performing a virtual surgical procedure such as the repair or fixing of a bone fracture. The tool also provides virtual objects including a virtual patient, implants, and instruments for performing the virtual surgical procedure. In other words, the user is provided with an interactive training experience by allowing the user to manipulate virtual objects in a virtual procedure and receive feedback of the performance of the steps in the virtual procedure. Such a virtual surgical experience provides training for the user which may help increase the success of a real surgical procedure.

The tool also provides the user with the capability of generating virtual radiographic images of a portion of the virtual patient during the virtual surgery, essentially in real-time. Such techniques may help improve the user's radiographic image reading skills without having the user exposed to real radiographic images. The tool also provides a virtual camera in the virtual operating room which the user can adjust to view the virtual operating room from different angles. The tool also allows the user to adjust visibility characteristics of the virtual objects such as causing the bone of the patient to be transparent during the process which is a helpful training feature. The tool provides the user with an option to command the tool to perform the virtual surgical procedure automatically allowing the user to learn the proper manner of performing the procedure. The tool can also assist the user during the virtual surgical procedure to allow the user to gain confidence in performing the virtual procedure as well as a real procedure. The tool also generates a score indicating the user's performance of the virtual surgical procedure. The score provides feedback to the user which may help identify the user's strengths and weaknesses related to the performance of the surgical procedure.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims.

What is claimed is:

1. A computer-implemented method of providing a virtual operating space for performing a virtual surgical procedure comprising:
generating a three-dimensional view of a virtual operating space comprising one or more virtual objects capable of being manipulated by a user for performing one or more operating steps in a virtual surgical procedure on one or more virtual patients;
manipulating the one or more virtual objects in the virtual operating space to perform all or part of a virtual surgical procedure; and
generating a virtual radiographic image of one or more portions of the virtual patient at least following the performance of one or more steps of the virtual surgical procedure to provide visual feedback to the user regarding the performance of the one or more steps in the virtual surgical procedure.

2. The method of claim 1, wherein the virtual radiographic image is a two-dimensional slice image of a patient.

3. The method of claim 2, wherein the user selects a slice plane of the radiographic image.

4. The method of claim 2, wherein the one or more operating steps are performed by the user via an input device.

5. The method of claim 1, further comprising providing a command to selectively adjust a visibility characteristic of the one or more objects.

6. The method of claim 5, wherein the visibility characteristic of the one or more objects comprises at least one of transparency and opaqueness.

7. The method of claim 1, further comprising providing command to initiate automatic manipulation of the one or more objects in the virtual operating space by the computer in accordance with the one or more predefined steps to demonstrate a predefined manner to perform the one or more steps in the virtual surgical procedure.

8. The method of claim 1, further comprising displaying both the three-dimensional view and two-dimensional view simultaneously on one or more output display devices.

9. The method of claim 1, wherein one or more of the objects comprise an object representing a virtual surgical tool and an object representing virtual implants.

10. The method of claim 1, wherein one of the objects is adapted to manipulate another object.

11. The method of claim 1, wherein at least one of the objects is constrained in terms of movement in the virtual operating space.

12. The method of claim 1, further comprising comparing results of the manipulation of the objects to predefined criteria and generating a score representing a result of the comparison.

13. The method of claim 1, wherein the one or more operating steps comprise a series of predefined steps for repairing a bone fracture.

14. The method of claim 13, wherein one of the operating steps comprises allowing the user to make a canal in an interior portion of the bone to allow insertion of the implant.

15. The method of claim 14, wherein one of the operating steps comprises allowing the user to insert the implant into the canal.

16. The method of claim 15, further comprising generating virtual radiographic images at least before one or more of the operating steps and after one or more of the operating steps.

17. The method of claim 15, wherein one or more of the operating steps for manipulating the virtual objects are restricted according to predefined boundaries.

18. A computer-readable medium having instructions executable by a processor for performing the method of claim 1.

19. An apparatus for providing a virtual operating space for performing a virtual surgical procedure, the apparatus comprising:
a processor; and
a storage device storing instructions that are executed by the processor to:
generate a three-dimensional view of a virtual operating space comprising one or more virtual objects capable of being manipulated by a user for performing one or more operating steps in a virtual surgical procedure on one or more virtual patients;
manipulate the one or more virtual objects in the virtual operating space to perform all or part of a virtual surgical procedure; and
generate a virtual radiographic image of one or more portions of the virtual patient at least following the performance of one or more steps of the virtual surgical procedure to provide visual feedback to the user regarding the performance of the one or more steps in the virtual surgical procedure.

20. A method of providing a virtual operating space for performing a virtual surgical procedure comprising:
generating a three-dimensional view of a virtual operating space of virtual objects comprising a virtual patient, at least one virtual bone forming a part of the virtual patient, at least one virtual implant and at least one virtual tool for implanting the implant in the bone;
manipulating the one or more virtual objects in the virtual operating space to perform all or part of the virtual orthopedic surgical procedure; and
generating a virtual radiographic image of one or more portions of the virtual patient at least following the performance of one or more steps of the virtual surgical procedure to provide visual feedback to the user regarding the performance of the one or more steps in the virtual surgical procedure.

21. An apparatus for providing a virtual operating space for performing a virtual surgical procedure, the apparatus comprising:
means for generating a three-dimensional view of a virtual operating space comprising one or more virtual objects capable of being manipulated by a user for performing one or more operating steps in a virtual surgical procedure on one or more virtual patients;
means for manipulating the one or more virtual objects in the virtual operating space to perform all or part of a virtual surgical procedure; and
means for generating a virtual radiographic image of one or more portions of the virtual patient at least following the performance of one or more steps of the virtual surgical procedure to provide visual feedback to the user regarding the performance of the one or more steps in the virtual surgical procedure.
